(19) United States
(12) Patent Application Publication
(10) Pub. No.: US 2003/0209523 A1
(43) Pub. Date: Nov. 13, 2003

(54) Planarization by chemical polishing for ULSI applications

(75) Inventors: Deenesh Padhi, San Jose, CA (US); Srinivas Gandikota, Santa Clara, CA (US); Chunping Long, Evanston, IL (US); Sivakami Ramanathan, Fremont, CA (US); Chris R. McGuirk, San Jose, CA (US); Girish Dixit, San Jose, CA (US); Muhammad Atif Malik, Santa Clara, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 10/143,401

(22) Filed: May 9, 2002

(51) Int. Cl. C03C 25/68; C23F 1/00

(52) U.S. Cl. 216/108; 216/100; 156/345.12

(57) ABSTRACT

Methods, compositions, and apparatus are provided for planarizing conductive materials disposed on a substrate surface by an chemical polishing technique. In one aspect, a substrate having conductive material disposed thereon is disposed on a substrate support and exposed to a composition containing an oxidizing agent and an inorganic etchant. The substrate is planarized by the composition without the presence of mechanical abrasion. The substrate may optionally be rotated, agitated, or both during exposure to the composition. The method removes conductive materials forming protuberances on the substrate surface at a higher rate than conductive materials forming recesses on the substrate surface.

### BACKGROUND OF THE INVENTION

1. Field of the Invention

The present invention generally relates to a process and apparatus for planarizing a conductive material on a substrate by a polishing technique.

2. Description of the Related Art

Reliably producing sub-half micron and smaller features is one of the key technologies for the next generation of very large scale integration (VLSI) and ultra large-scale integration (ULSI) of semiconductor devices. However, as the limits of circuit technology are pushed, the shrinking dimensions of interconnects in VLSI and ULSI technology have placed additional demands on the processing capabilities. Reliable formation of these interconnects is important to VLSI and ULSI success and to the continued effort to increase circuit density and quality of individual substrates and die.

Interconnects and multilevel interconnects are formed using sequential material deposition and material removal techniques of conducting, semiconducting, and dielectric materials, on a substrate surface to form features therein. As layers of materials are sequentially deposited and removed, the uppermost surface of the substrate may become non-planar across its surface and require planarization prior to further processing.

Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing. One technique to planarize a substrate surface is chemical mechanical planarization, or chemical mechanical polishing (CMP), which utilizes a chemical composition, typically a slurry or other fluid medium, along with mechanical abrasion of the substrate surface to remove material therefrom.

One material of choice for use in forming ULSI interconnects that provide the conductive pathway in integrated circuits and other electronic devices is copper. Copper is a material having advantageous properties such as lower resistance and better electromigration performance compared to traditional materials such as aluminum. However, copper is difficult to pattern and etch. Accordingly, copper features are formed using damascene or dual damascene processes.

In damascene processes, a feature is defined in a dielectric material and subsequently filled with copper. A barrier layer is deposited conformally on the surfaces of the features formed in the dielectric layer prior to deposition of the copper. Copper is then deposited over the barrier layer and the surrounding field. The copper deposited on the field is removed by CMP processes to leave the copper filled feature formed in the dielectric material.

However, substrate surfaces may have different surface topography, depending on the density or size of features formed therein, which makes effective conformal removal of copper material from the substrate surface difficult to achieve with CMP techniques. For example, in CMP techniques, copper material is observed to be removed from a dense feature area of the substrate surface at a slower removal rate as compared to removing copper material from a substrate surface area having few, if any, features formed therein. Additionally, the relatively uneven removal rates can result in underpolishing of areas of the substrate with residual copper material remaining after the polishing process. Residual copper material can detrimentally affect device formation, such as creating short-circuits within or between devices, and thereby reduce device yields and reduce substrate throughput, as well as detrimentally affect the polish quality of the substrate surface.

One solution to removing all of the desired copper material from the substrate surface is overpolishing the substrate surface by increasing polishing time or increasing polishing pressures. However, overpolishing of some materials can result in the formation of topographical defects, such as concavities or depressions in features, referred to as dishing, or excessive removal of dielectric material, referred to as erosion. The topographical defects from dishing and erosion can further lead to non-uniform removal of additional materials, such as barrier layer materials disposed thereunder, and produce a substrate surface having a less than desirable polishing quality.

Another difficulty with the polishing of copper surfaces arises from the semiconductor's increasing use of low dielectric constant (low k) dielectric materials to form copper damascenes. Low k dielectric materials are used as insulating layers in forming dual damascene definitions to reduce the capacitive coupling between adjacent interconnects. Increased capacitative coupling between layers can detrimentally affect the functioning of semiconductor devices. However, low k dielectric materials, such as carbon doped silicon oxides, often form porous, brittle structures, that may deform or scratch under conventional polishing pressures, called downforce. Deformation and scratching of the low k materials can detrimentally affect substrate polish quality and detrimentally affect device formation.

One solution to the difficulties with conventional chemical mechanical polishing of copper and low k dielectric materials is to remove deposited material by an electropolishing technique. Electropolishing removes conductive materials, such as copper, from a substrate surface by electrochemical dissolution. However, electropolishing typically requires additional hardware and power sources that increase mechanical complexity and maintenance of such apparatus. Additionally, electropolishing has been observed to provide a slower polishing rate than chemical mechanical polishing processes.

Electropolishing has also been observed to remove conductive material near electrical contacts at higher rates than other locations of a substrate surface and provide insufficient planarity when polishing substrates. For example, electropolishing techniques may remove the material from protuberances, or peaks, formed over dense features, and recesses, or valleys, formed over wide features at rates that are not sufficiently different and result in an unsatisfactory degree of non-planarity. Techniques having removal rates that are not sufficiently different are limited in the amount of material that can be removed by the electropolishing technique to the amount of material disposed above the recesses to avoid dishing or forming other topographical defects. Additional polishing techniques may still be required.

Therefore, there is a need for an apparatus, method, and composition for planarizing a metal layer on a substrate.

### SUMMARY OF THE INVENTION

Aspects of the invention described herein generally relate to methods, compositions, planarizing conductive material disposed on a substrate surface by a chemical polishing technique. In one aspect, a method is provided for processing a substrate including depositing conductive metal on a substrate surface by an electroplating technique, exposing the substrate surface to a composition comprising an oxidizing agent and an etchant, and removing conductive material from protuberances at a greater rate than conductive material from recesses.

In another aspect, a method is provided for removing an electroplated conductive material from protuberances at a greater rate than conductive material from recesses formed on a substrate surface having a low k material and apertures formed therein, including depositing conductive metal on a substrate surface and in the apertures by an electroplating technique, exposing the substrate surface to a composition comprising between about 5 vol % and about 40 vol % of an oxidizing agent and between about 0.5 vol % and about 20 vol % of an acid, rotating the substrate at a rotational speed at about 1000 rpm or less during chemical polishing, and applying a source of agitation to the substrate.

In another aspect, a method is provided for polishing a substrate, including electroplating a metal layer on a substrate surface, removing at least a portion of the metal layer in situ by a method including exposing the substrate surface to a composition comprising between about 5 vol % and about 40 vol % of hydrogen peroxide, nitric acid, or combinations thereof, and between about 0.5 vol % and about 20 vol % of sulfuric acid, phosphoric acid, acetic acid, or combinations thereof, rotating the substrate at a rotational speed at about 10 rpm or less, and applying a source of agitation to the substrate.

In another aspect, a method is provided for planarizing a patterned substrate having an electroplated conductive metal layer disposed thereon, the method including exposing the substrate to a liquid composition comprising a first component selected from the group of hydrogen peroxide, nitric acid, and combinations thereof, and a second component selected from the group of sulfuric acid, phosphoric acid, acetic acid, and combinations thereof and rotating the substrate at a rotational speed of the order of 1000 rpm or less.

In another aspect, a processing system is provided for processing a substrate, the system including an electroplating processing mainframe having a transfer robot and one or more chemical polishing cells, a chemical polishing composition applicator coupled to the mainframe, the applicator comprising a nozzle positioned to distribute a chemical polishing composition over the substrate, and a chemical polishing composition supply fluidly connected to the chemical polishing composition applicator.

### BRIEF DESCRIPTION OF THE DRAWINGS

So that the manner in which the features of the invention described herein are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a perspective view of one embodiment of a system platform for performing the processes described herein;

FIG. 2 is a top plan view of one embodiment of a system platform for performing the processes described herein;

FIG. 3 is a schematic side view of one embodiment of a chemical polishing apparatus for performing the processes described herein;

FIG. 4 is a schematic side view of another embodiment of a chemical polishing apparatus for performing the processes described herein; and

FIG. 5 is a schematic side view of another embodiment of a chemical polishing apparatus for performing the processes described herein;

FIGS. 6A-6B are a series of schematic side views of a substrate processed by one embodiment of the processes described herein.

### DETAILED DESCRIPTION OF THE PREFERRED EMBODIMENT

Aspects of the invention described herein generally relate methods, compositions, and apparatus, for planarizing a substrate surface by removing conductive material therefrom by a chemical polishing technique. The words and phrases used herein should be given their ordinary and customary meaning in the art by one skilled in the art unless otherwise further defined. Chemical polishing should be broadly construed and includes, but is not limited to, planarizing a substrate by the application of chemical activity. Planarizing should be broadly construed and includes minimizing or reducing surface topography with the intent to produce a flat, smooth surface. Bulk material should be broadly construed and includes, but is not limited to, material deposited on the substrate in an amount more than sufficient to substantially fill features formed on the substrate surface. Agitation should be broadly construed and includes, but is not limited to, vibration or other physical displacement of one or more materials in one or more directions. For example, ultrasonic or megasonic agitation of a substrate disposed in an electrolyte solution includes moving the substrate and the surrounding electrolyte solution in both vertical and horizontal directions.

The invention will be described below in reference to a chemical polishing process performed in a processing chamber adapted to perform chemical polishing. The processing chamber may be disposed in a processing system, such as the Electra Cu™ ECP platform commercially available from Applied Materials, Inc., located in Santa Clara, Calif.

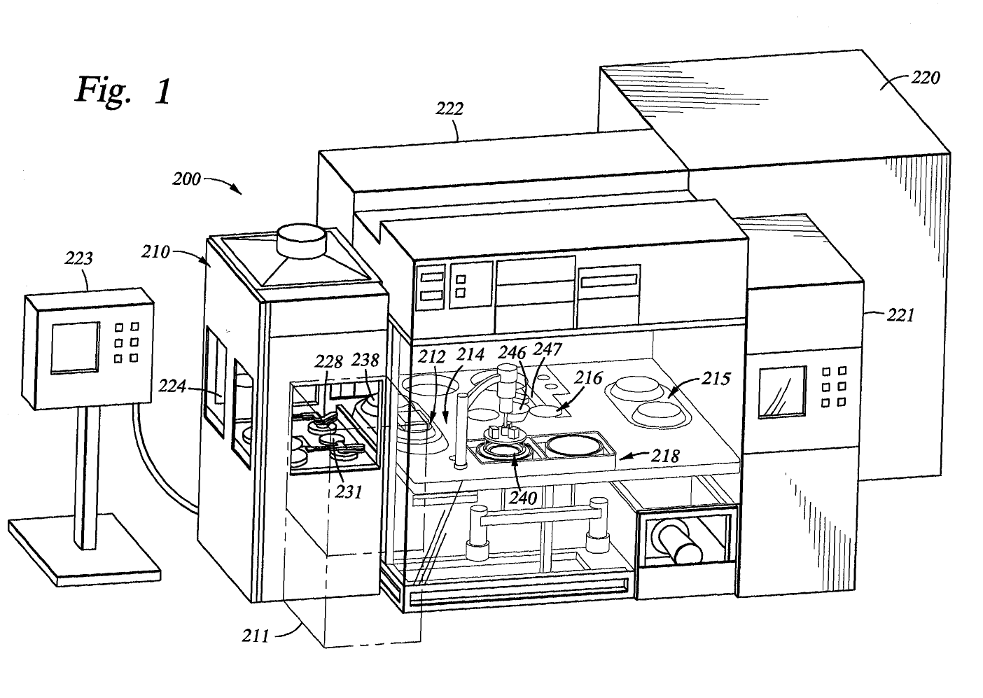

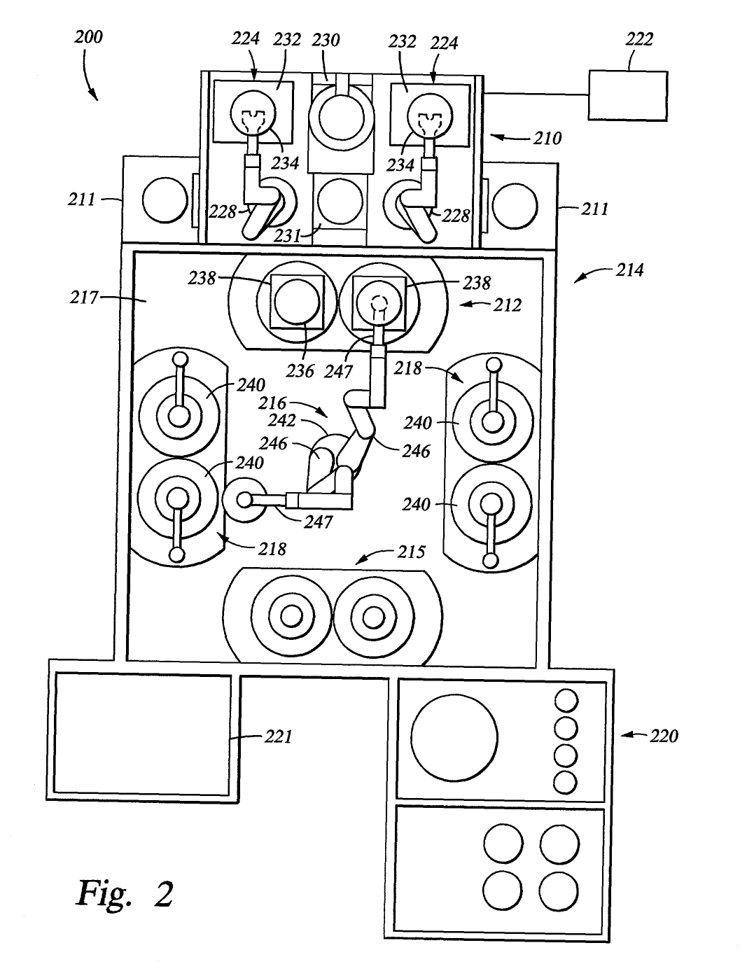

FIG. 1 is a perspective view of a system platform 200 in which the chemical polishing process can be performed and is described in U.S. Pat. No. 6,258,220, issued Jul. 10, 2001, and U.S. Pat. No. 6,258,223, issued Jul. 10, 2001, which are incorporated herein by reference to the extent not inconsistent with the claimed aspects and disclosure herein. FIG. 2 is a schematic top view of a system platform 200. Referring to both FIGS. 1 and 2, the system platform 200 generally comprises a loading station 210, a thermal anneal chamber 211, a mainframe 214, and an electrolyte replenishing system 220. The mainframe 214 generally comprises a mainframe transfer station 216, a spin-rinse dry (CP/SRD) station 212, a plurality of processing stations 218, and a chemical polishing station 215. The system platform 200, particularly the mainframe 214, may be enclosed in a clean environment using panels such as Plexiglas panels. The mainframe 214 includes a base 217 having cut-outs to support various stations needed to complete the electro-chemical deposition process. Each processing station 218 includes one or more processing cells 240. An electrolyte replenishing system 220 is positioned adjacent the mainframe 214 and connected to the process cells 240 individually to circulate electrolyte used for the electroplating process or polishing compositions for the chemical polishing process. The system platform 200 also includes a power supply station 221 for providing electrical power to the system and a control system 222, typically comprising a programmable microprocessor.

The loading station 210 may include one or more substrate cassette receiving areas 224, one or more loading station transfer robots 228 and at least one substrate orientor 230. As shown for one embodiment in FIGS. 1 and 2, the loading station 210 includes two substrate cassette receiving areas 224, two loading station transfer robots 228 and one substrate orientor 230. A substrate cassette 232 containing substrates 234 is loaded onto the substrate cassette receiving area 224 to introduce substrates 234 into the system platform. The loading station transfer robot 228 transfers substrates 234 between the substrate cassette 232 and the substrate orientor 230. The substrate orientor 230 positions each substrate 234 in a desired orientation to ensure that the substrate is properly processed. The loading station transfer robot 228 also transfers substrates 234 between the loading station 210 and the SRD station 212 and between the loading station 210 and the thermal anneal chamber 211. The loading station 210 may also include a substrate cassette 231 for temporary storage of substrates as needed to facilitate efficient transfer of substrates through the system.

FIG. 2 also shows a mainframe transfer robot 242 having a flipper robot 247 incorporated therein. The mainframe transfer robot 242 serves to transfer substrates between different stations attached to the mainframe station, including the processing stations and the SRD stations. The mainframe transfer robot 242 includes a plurality of robot arms 246 (two shown), and a flipper robot 247 is attached as an end effector for each of the robot arms 246. Flipper robots are generally known in the art and can be attached as end effectors for substrate handling robots, such as model RR701, available from Rorze Automation, Inc., located in Milpitas, Calif. The main transfer robot 242 having a flipper robot as the end effector is capable of transferring substrates between different stations attached to the mainframe as well as flipping the substrate being transferred to the desired surface orientation. For example, the flipper robot flips the substrate processing surface face-down for the electroplating process in the processing cell 240 and flips the substrate processing surface face-up for other processes, such as the chemical polishing process or spin-rinse-dry process. The mainframe transfer robot 242 may provide independent robot motion along the X-Y-Z axes by the robot arm 246 and independent substrate flipping rotation by the flipper robot end effector 247.

The rapid thermal anneal (RTA) chamber 211 may be connected to the loading station 210, and substrates are transferred into and out of the RTA chamber 211 by the loading station transfer robot 228. The system 200, for example, comprises two RTA chambers 211 disposed on opposing sides of the loading station 210, corresponding to the symmetric design of the loading station 210.

The SRD module 212 is disposed adjacent the loading station 210 and serves as a connection between the loading station 210 and the mainframe 214. Referring to FIGS. 1 and 2, the mainframe 214, as shown, includes two processing stations 218 disposed on opposite sides, each processing station 218 having two processing cells 240. The mainframe transfer station 216 includes a mainframe transfer robot 242 disposed centrally to provide substrate transfer between various stations on the mainframe. The mainframe transfer robot 242 may comprise a plurality of individual robot arms 246 that provides independent access of substrates in the processing stations 218, the CP/SRD stations 212, the chemical polishing stations 215, and other processing stations disposed on or in connection with the mainframe. As shown in FIG. 1, the mainframe transfer robot 242 comprises two robot arms 246, corresponding to the number of processing cells 240 per processing station 218. Each robot arm 246 includes an end effector for holding a substrate during a substrate transfer. Each robot arm 246 may be operable independently of the other arm to facilitate independent transfers of substrates in the system. Alternatively, the robot arms 246 operate in a linked fashion such that one robot extends as the other robot arm retracts.

The system platform 200 includes a control system 222 that controls the functions of each component of the platform. The control system 222 may be mounted above the mainframe 214 and comprises a programmable microprocessor. The programmable microprocessor is typically programmed using software designed specifically for controlling all components of the system platform 200. The control system 222 also provides electrical power to the components of the system and includes a control panel 223 that allows an operator to monitor and operate the system platform 200. The control panel 223 is a stand-alone module that is connected to the control system 222 through a cable and provides easy access to an operator. Generally, the control system 222 coordinates the operations of the loading station 210, the RTA chamber 211, the SRD station 212, the mainframe 214 and the processing stations 218. Additionally, the control system 222 coordinates with the controller of the electrolyte replenishing system 220 to provide the electrolyte for the electroplating process and to provide the polishing composition for the chemical polishing process.

The chemical polishing process may be performed in existing apparatus, such as in an electroless deposition processing (EDP) cell. A CP cell that is used to perform a chemical polishing process will herein be referred to as a chemical polishing (CP) cell. The CP cell can be disposed in the chemical polishing stations 215 described herein. In the embodiment shown, two CP cells can be arranged side-by-side for greater throughput rates. However the CP cell may be disposed in alternative placed, such as in the position of a SRD station 212.

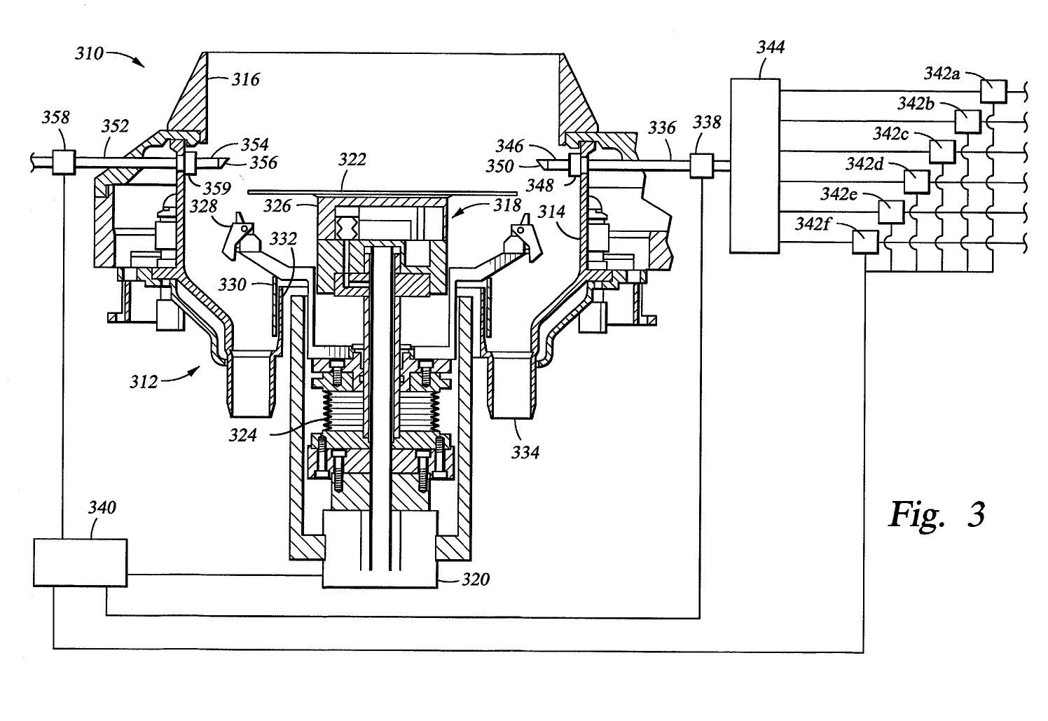

FIG. 3 is a schematic perspective view of one CP cell 310 suitable for performing the chemical polishing process described herein. The CP cell 310 includes a bottom 312, a sidewall 314, and an angularly disposed upper shield 316 attached to the sidewall 314 and open in the middle of the shield. Alternatively, a removable cover (not shown) could be used.

A pedestal 318 is generally disposed in a central location of the cell 310 and includes a pedestal actuator 320. The pedestal actuator 320 rotates the pedestal 318 to spin a substrate 322 mounted thereon between about 10 to about 2000 RPMs. The pedestal can be heated so that the substrate temperature is between about 15° C. to about 100° C. A pedestal lift 324 raises and lowers the pedestal 318. The substrate 322 can be held in position by a vacuum chuck 326 mounted to the top of the pedestal 318.

The pedestal 318 may be adapted to generate or act as a medium for the transference of ultrasonic or megasonic energy to a substrate surface during processing. For example, ultrasonic or megasonic energy, and thus agitation, may be provided by one or more typical Piezo-electric crystal transducers (not shown), which are commonly known, coupled to a power supply. Applied power, such as Watts, or power density Watts/square centimeter, is applied to the sources of ultrasonic or megasonic energy, which is then converted to ultrasonic or megasonic energy applied to the substrate surface. The source of ultrasonic or megasonic agitation may be coupled to the pedestal 318 and provide agitation indirectly to the substrate via the pedestal 318. If more than one transducer is used, the multiple transducers may be mounted on the same or different components. Additionally, the source of the ultrasonic or megasonic agitation may be internally contained or integrated in the pedestal 318 and provide agitation directly from the source to the substrate. An example of such a pedestal is the wet clean pedestal disposed in the Tempest™ processing chamber commercially available from Applied Materials, of Santa Clara, Calif.

In addition, the pedestal 318 can lower the substrate 322 to a vertical position aligned with a plurality of clamps 328. The clamps 328 pivot with centrifugal force and engage the substrate 322 typically on an edge of the substrate. The pedestal 318 also includes a downwardly disposed annular shield 330 of greater diameter than a corresponding upwardly disposed annular shield 332 coupled to the bottom of the cell 310. The interaction of the two annular shields 330, 332 protects the pedestal 318 and associated components from the fluids in the cell 310. At least one fluid outlet 334 is disposed in the bottom of the cell 310 to allow fluids to exit the cell.

A first conduit 336, through which a chemical polishing composition fluid flows, is coupled to the cell 310. The conduit 336 can be a hose, pipe, tube, or other fluid containing conduit. A chemical polishing fluid valve 338 controls the flow of the chemical polishing composition, where the valves disclosed herein can be a needle, globe, butterfly, or other type of valve and can include a valve actuator, such as a solenoid. A chemical polishing composition container 344 is connected to the valve 338 that can be controlled with a controller 340. A series of valves 342a-f are connected to various chemical sources (not shown), where the valves 342a-f can be separately controlled with the controller 340. The chemical polishing composition fluid may be mixed on an as-needed basis in individual application quantities for deposition on the substrate 322 and not significantly before the deposition to avoid premature chemical reaction of components in the conduit 336 and associated elements. The valves 338, 342a-f may therefore be located in close proximity to the cell 310. The first conduit 336 connects to an first fluid inlet 346 disposed above the substrate 322 when the substrate is disposed in a lowered position and may be coupled to an articulating member 348, such as a ball and socket joint, to allow movement of the inlet 346 and to allow adjustment of the angle of the inlet 346 in the cell 310. A first nozzle 350 is connected to the end of the inlet 346 and is directed toward the pedestal 318. The fluid(s) is generally delivered in a spray pattern, which may be varied depending on the particular nozzle spray pattern desired and may include a fan, jet, conical, and other patterns. The nozzle 350 may be located outside the periphery of the substrate 322 to allow the substrate to be raised and lowered without interference. Alternatively, the nozzle 350 can be articulated toward the periphery of the cell 310 with an actuator (not shown) that moves the nozzle 350 laterally, vertically or some combination thereof to provide vertical clearance for the substrate 322 as the substrate is raised or lowered.

Similar to the first conduit and related elements, a second conduit 352 is disposed through the sidewall 314. The second conduit 352 provides a path for rinsing fluid, such as deionized water or alcohol, that is used to rinse the substrate 322 after the chemical polishing process. A second inlet 354 is connected to the second conduit 352 and a second nozzle 356 is connected to the second inlet 354. An articulating member 359 is coupled to the second inlet 354 and can be used to allow movement and adjustment of the angle of the inlet relative to the cell 310. A second valve 358 is connected to the second conduit 352 and may also control the rinsing fluid timing and flow. The second conduit can also be coupled to a source of rinsing agent or other fluids and a valve for controlling the fluid. For example, the rinsing agent may contain an etchant, such as hydrochloric acid, sulfuric acid, phosphoric acid, hydrofluoric acid, or a corrosion inhibitor, such as benzotriazole that can be used to coat the substrate surface after the chemical polishing process to protect the layer from oxidation and other contaminants prior to subsequent processing.

The controller 340 may control each valve and therefore each fluid timing and flow. The controller 340 may also control the substrate spin and raising and lowering of the pedestal and hence the substrate disposed thereon. The controller 340 could be remotely located, for instance, in a control panel (not shown) or control room and the plumbing controlled with remote actuators.

In operation, a robot (not shown) delivers the substrate 322 face up to the CP cell 310. The substrate 322 already has a seed layer deposited thereon, such as by physical vapor deposition technique, and a fill layer, such as by an electroplating technique. The fill layer is deposited to fill apertures formed in a substrate surface and is typically deposited to excess to ensure fill of the features. The pedestal raises 318 and the vacuum chuck 326 engages the underside of the substrate 322. The robot retracts and the pedestal 318 lowers to a processing elevation. The controller 340 actuates the valves 342a-f to provide chemicals into the chemical polishing fluid container 344, the chemicals are mixed, and the controller actuates the chemical polishing fluid valve 338 to open and allow a certain quantity of chemical polishing composition into the first inlet 346 and through the first nozzle 350. The pedestal 318 can spin at a relatively slow speed of about 10 to about 500 RPMs, allowing a quantity of fluid to uniformly coat the substrate 322. The spin direction can be reversed in an alternating fashion to assist in spreading the fluid evenly across the substrate. The chemical polishing fluid valve 338 is closed. The chemical polishing composition reacts with the deposited material to etch and remove material.

The second valve 358 opens and a rinsing fluid flows through the second conduit 352 and is sprayed onto the substrate 322 through the second nozzle 356. The pedestal 318 may rotate at a faster speed of about 100 to about 500 RPMs as the remaining chemical polishing composition is rinsed from the substrate 322 and is drained through the outlet 334 and discarded. The substrate can be coated with an acid or other coating fluid. In some instances, the pedestal 318 can spin at a higher speed of about 500 to about 2000 RPMs to spin dry the substrate 322.

The pedestal 318 stops rotating and raises the substrate 322 to a position above the CP cell 310. The vacuum chuck 326 releases the substrate 322 and the robot retrieves the substrate for further processing in the electroplating cell.

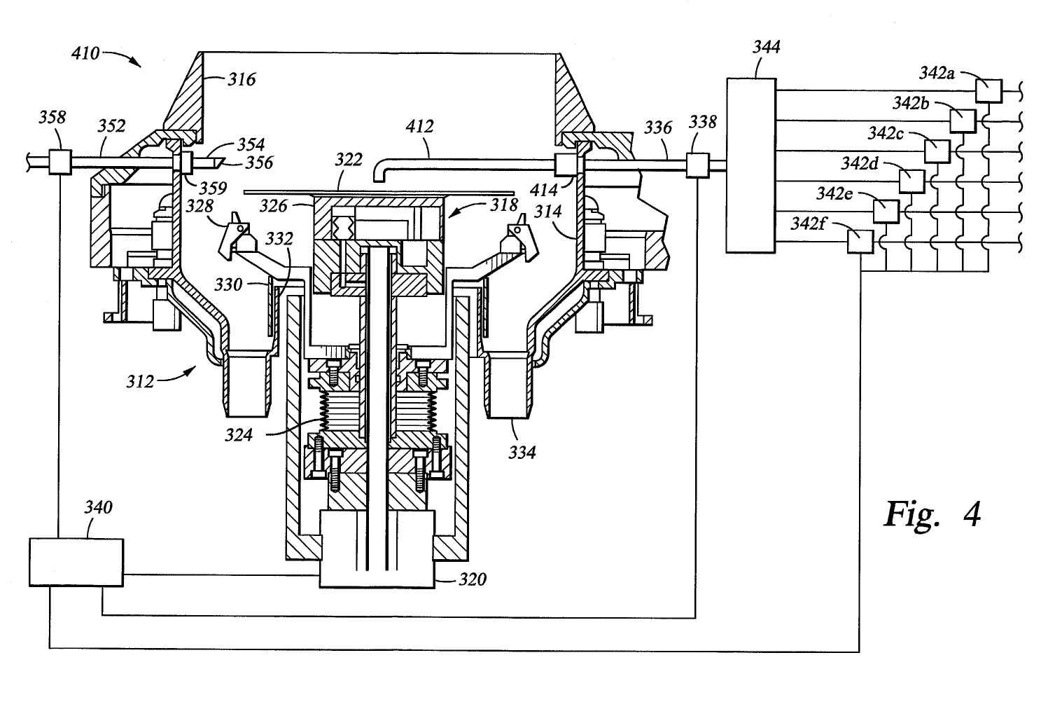

FIG. 4 is a schematic side view of an alternative embodiment of a CP cell. The CP cell 410 is similar to the CP cell 310 shown in FIG. 3 and includes similar conduits and valving, a pedestal, vacuum chuck, and a pedestal lift. The principal difference in CP cell 410 is a first inlet 412 that extends toward the center of the pedestal 318 and the substrate 322. The first inlet 412 articulates about an articulating member 414 disposed in proximity to the sidewall 314. An actuator (not shown) is coupled to the first inlet 412 and the sidewall 314 to provide movement of the first inlet 412 from a central position above the substrate 322 to a peripheral position proximate the sidewall 314 when the substrate 322 is raised and lowered in the cell 410. The controller 340 can also control the actuator. The first inlet is also adapted to move in a transversal motion, or “sweep”, across the surface of the substrate from the center of a substrate to an edge and then to the center again. During delivery of the polishing composition, the inlet 412 is generally moved along the cycle from the center to edge to center again at between about 10 times a second to once every ten seconds, for example, about one cycle per second (1 Hz).

In operation, the substrate 322 is delivered to the CP cell 410 by a robot (not shown). The substrate 322 is lowered on the vacuum chuck 326 below the vertical elevation of the first inlet 412. The first inlet 412 is pushed to a central position above the substrate 322 by the actuator. The valves 342a-f allow appropriate quantities of chemicals into the container 344 for mixing and the valve 338 opens to allow a quantity of chemical polishing composition into the first inlet 412. The first inlet 412 drops a quantity of chemical polishing composition onto the substrate 322 and the pedestal 318 spins the substrate at an RPM adapted to displace the liquid across the substrate surface in a substantially uniform fashion. Depending on the viscosity of the liquid, the rotational speed of the substrate 322 can be from about 10 to about 500 RPMs. The spin direction of the pedestal can be reversed to assist in even distribution of the fluid. The substrate 322 can be rinsed as described in reference to FIG. 3. The actuator moves the first inlet 412 toward the sidewall 314 of the cell 410 and the pedestal 318 raises the substrate 322 through the top of the cell 410 to be retrieved by the robot.

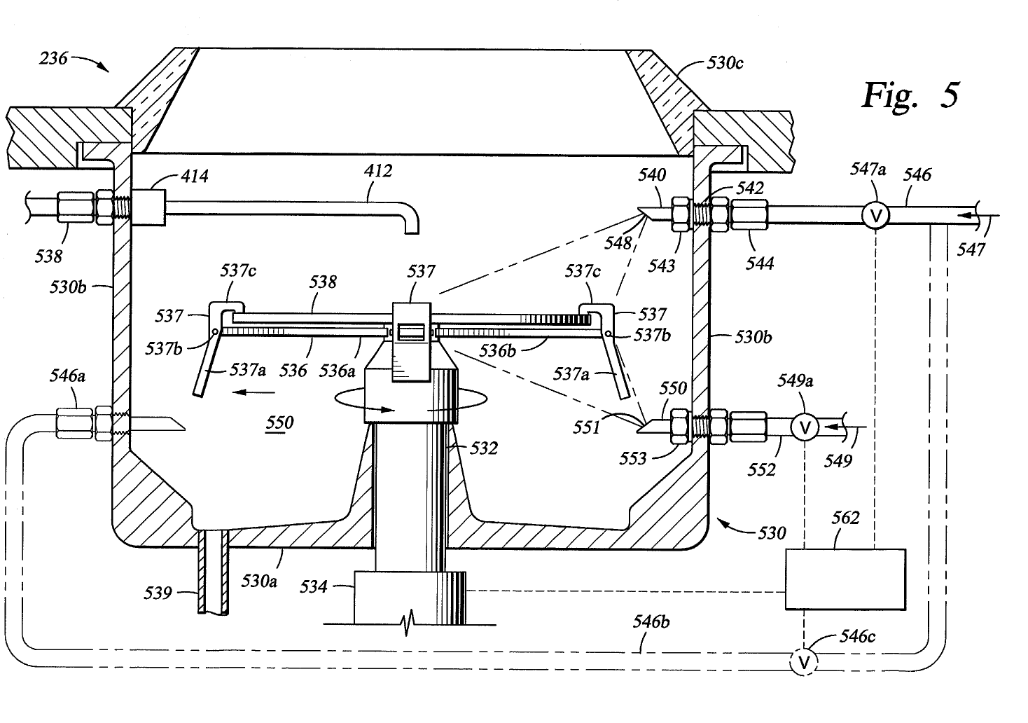

Another option for a chemical polishing using the chemical polishing process is to combine the CP cell with the SRD cell to form a CP/CP/SRD cell or module. For instance, the first conduit 336 and first inlet 412 described in reference to FIG. 5 with associated valving, such as valve 338, can be included with the CP/SRD cell described as follows.

The CP/SRD cell comprises a bottom 530a, a sidewall 530b, and an upper shield 530c that collectively define a CP/SRD cell bowl 530d, where the shield attaches to the sidewall and assists in retaining the fluids within the CP/SRD cell. A pedestal 536, located in the CP/SRD cell, includes a pedestal support 532 and a pedestal actuator 534. The pedestal 536 supports a substrate 538 (shown in FIG. 5) on the pedestal upper surface during processing. The pedestal actuator 534 rotates the pedestal 536 to spin the substrate 538 and raises and lowers the pedestal as described below. The substrate may be held in place on the pedestal by a plurality of clamps 537. The clamps 537 pivot with centrifugal force and may be coupled to the substrate in the edge exclusion zone of the substrate. The pedestal has a plurality of pedestal arms 536a and 536b, so that the fluid through the second nozzle may impact as much surface area on the lower surface of the substrate as is practical. An outlet 539 allows fluid to be removed from the CP/SRD cell.

A first conduit 546 in the CP/SRD cell, through which a first fluid 547 flows, is connected to a valve 547a. The valve 547a controls the flow of the first fluid 547 and may include a valve actuator, such as a solenoid, that can be controlled with a controller 562. The conduit 546 connects to a first fluid inlet 540 that is located above the substrate and includes a mounting portion 542 to attach to the CP/SRD cell and a connecting portion 544 to attach to the conduit 546. The first fluid inlet 540 is shown with a single first nozzle 548 to deliver a first fluid 547 onto the substrate upper surface. However, multiple nozzles could be used and multiple fluid inlets could be positioned about the inner perimeter of the SRD module 236. The first fluid 547 may be the polishing composition.

Similar to the first conduit 546 and related elements described above, a second conduit 552 is connected to a control valve 549a and a second fluid inlet 550 with a second nozzle 551. The second fluid inlet 550 is shown below the substrate and angled upward to direct a second fluid under the substrate 538 through the second nozzle 551. Similar to the first fluid inlet 540, the second fluid inlet 550 may include a plurality of nozzles, a plurality of fluid inlets and mounting locations, and a plurality of orientations including using the articulating member 553. Each fluid inlet could be extended into the SRD module 236 at a variety of positions. The second fluid is a cleaning or rinsing agent as described above for the CP cell 310.

A first inlet 412 is disposed through the sidewall 530b and extending to a central position above the substrate 538. The first inlet 412 is connected to the valve 538 and may be used to control a quantity of chemical polishing composition delivered through the first inlet to the substrate. An actuator is connected to the first inlet 412 and can be used to articulate the first inlet 412 about an articulating member 414 from the central position to a peripheral position in proximity to the sidewall 530b.

The controller 562 could individually control the chemical polishing composition and a rinsing compound and their respective flow rates, pressure, and timing, and any associated valving, as well as the spin cycle(s). The controller could be remotely located, for instance, in a control panel or control room and the plumbing controlled with remote actuators.

In one embodiment, the substrate is mounted with the deposition surface face up in the CP/SRD cell bowl. As will be explained below, for such an arrangement, the first fluid inlet 540 would generally flow the polishing composition, for example, as described herein. Consequently, the backside of the substrate would be mounted facing down and a fluid flowing through the second fluid inlet 550 would be a dissolving fluid or rinsing agent, such as an acid, including hydrochloric acid, sulfuric acid, phosphoric acid, hydrofluoric acid, or other dissolving liquids or water, depending on the material to be dissolved or cleaned. Alternatively, the rinsing agent may also include the polishing composition.

In operation, the pedestal 536 is in a raised position, shown in FIG. 5, and a robot (not shown) places the substrate 538, face up, onto the pedestal. The pedestal lowers the substrate to a processing position where the substrate is vertically disposed between the first and the second fluid inlets. Generally, the pedestal actuator 534 rotates the pedestal between about 5 to about 5000 rpm, with a typical range between about 20 to about 2000 rpm for a 200 mm substrate. The rotation causes the lower end 537a of the clamps to rotate outward about pivot 537b, toward the periphery of the CP/SRD cell sidewall 530b, due to centrifugal force. The clamp rotation forces the upper end 537c of the clamp inward and downward to center and may hold substrate 538 in position on the pedestal 536 along the substrate edge. The clamps may rotate into position without touching the substrate and hold the substrate in position on the pedestal only if the substrate 328 significantly lifts off the pedestal 336 during processing.

With the pedestal rotating the substrate, the polishing composition is delivered onto the substrate face through the first fluid inlet 540 and/or inlet 412. The second fluid may concurrently or sequentially be delivered to the backside surface through the second fluid inlet to remove any unwanted deposits. The polishing composition chemically reacts with the deposited material and dissolves and then flushes the material away from the substrate, such as excess deposited material. After polishing and rinsing the face and/or rinsing the backside of the substrate, the fluid(s) flow is stopped and the pedestal continues to rotate, spinning the substrate, and thereby effectively drying the surface.

The polishing composition is generally delivered in a spray pattern, which may be varied depending on the particular nozzle spray pattern desired and may include a fan, jet, conical, and other patterns.

The CP cells can be disposed in a variety of locations in the processing system. In addition to the referenced location at the rearward position of the system 200 the CP cell(s) can also be located above the SRD module 236 shown in FIGS. 1 and 2. For instance, as described in reference to FIGS. 1 and 2, the substrate pass-through cassette 238 is positioned above each SRD module 236 and allows the loading station transfer robot 228 to deliver the substrate and the mainframe transfer robot 242 to retrieve the substrate. Likewise, a CP cell could be disposed above an CP/SRD module instead of the pass-through cassette so that the loading station transfer robot 228 delivers the substrate to the CP cell and the mainframe transfer robot 242 retrieves the substrate from the CP cell subsequent to an chemical polishing process in the CP cell.

The following is a description of a typical substrate process sequence through the system platform 200. The process sequence described below is exemplary of various other process sequences or combinations that can be performed utilizing the electro-chemical deposition platform. A substrate cassette containing a plurality of substrates is loaded into the substrate cassette receiving areas 224 in the loading station 210 of the system platform 200. In a preferred process, the substrates have had a seed layer of conductive material such as copper deposited thereon by a PVD process in a PVD chamber 100 prior to loading the substrates into the system 200. A loading station transfer robot 228 picks up a substrate from a substrate slot in the substrate cassette and places the substrate in the substrate orientor 230. The substrate orientor 230 determines and orients the substrate to a desired orientation for processing through the system. The loading station transfer robot 228 then transfers the oriented substrate from the substrate orientor 230 and positions the substrate in one of the substrate slots in the substrate pass-through cassette 238 at the SRD station 212. The mainframe transfer robot 242 picks up the substrate from the substrate pass-through cassette 238 and secures the substrate on the flipper robot end effector 247.

The mainframe transfer robot transfers the substrate to the processing cell 240 for the electroplating process. Alternatively, the substrate can be transferred to the CP/SRD cell for rinsing and drying, before transfer to the processing cell. The flipper robot end effector 247 rotates and positions the substrate face down in the electroplating cell for processing.

After the electroplating process has been completed, the mainframe transfer robot retracts the flipper robot end effector with the substrate out of the processing cell 240 and the flipper robot end effector flips the substrate from a face-down position to a face-up position.

The substrate is then transferred into the CP station for chemical polishing processing. The mainframe transfer robot retracts the substrate out of the CP cell 212. The substrate is then chemically polishing and cleaned using the chemical polishing process described herein and a spin-rinse-dry process in the SRD module 238 using deionized water or a combination of deionized water and a cleaning fluid. The substrate is then positioned for transfer out of the SRD module for further processing, such as annealing.

Chemical Polishing Process

One embodiment of the chemical polishing process includes positioning a substrate having conductive material disposed thereon on a substrate support, exposing a substrate surface to a composition comprising an oxidizing agent and an etchant, and polishing the substrate to remove conductive material disposed on the substrate to planarize the substrate surface by removal of bulk conductive material disposed thereon. The substrate may be rotated or agitated to during polishing to improve planarity of the substrate surface. The chemical polishing process can be used to remove conductive material forming protuberances at a greater rate than conductive material forming recesses in the substrate surface, thereby improving the planarity of the substrate surface.

Features of conductive materials are typically formed by etching an aperture in a dielectric material formed on a substrate surface and then depositing a barrier layer, an optional seed layer, prior to depositing the conductive material. The dielectric material may comprise any of various dielectric materials known or unknown that may be employed in the manufacture of semiconductor devices. Apertures are generally formed in the dielectric material by conventional photolithographic and etching techniques.

Suitable dielectric materials include silicon dioxide, phosphorus-doped silicon glass (PSG), boron-phosphorus-doped silicon glass (BPSG), and carbon-doped silicon dioxide. The dielectric layer may also include low dielectric constant (low k) materials, including fluoro-silicon glass (FSG), polymers, such as polymides, silicon carbide, such as BLOk™ dielectric materials, available from Applied Materials, Inc. of Santa Clara, Calif., and carbon-containing silicon oxides, such as Black Diamond™ dielectric materials, available from Applied Materials, Inc. of Santa Clara, Calif.

A barrier layer is used to prevent interlayer diffusion between the conductive material and the underlying dielectric material. The barrier layer is a suitable barrier layer for a deposited conductive material, for example for copper, barrier layer materials may include tantalum, tantalum nitride, tungsten, tungsten nitride, titanium nitride or combinations thereof, among others. However, the invention contemplates the use of additional barrier materials for copper material or other conductive materials that may be deposited on the substrate surface. The barrier layer material may be deposited by a chemical vapor deposition technique or another physical vapor deposition technique.

The optional seed layer is deposited on the barrier layer to nucleate the deposition of the conductive layer in the apertures. The seed layer typically comprises a conductive material, such a copper seed layer for a copper material deposition. The seed layer may contain boron, phosphorus, or other dopants to improve nucleation or improved film properties of the deposited conductive material.

The conductive material may be deposited by a physical vapor deposition method, a chemical vapor deposition method, an electroplating method, or an electroless method. Typically, the conductive layer is depositing by an electroplating method. An example of an electroplating process is more fully described in U.S. Pat. No. 6,113,771, issued on Sep. 5, 2000, which is incorporated by reference herein to the extent not inconsistent with the claims aspects or disclosure herein. The conductive material may comprise, for example, copper, copper alloys, or doped copper, and the invention contemplates the removal of other materials, such as tungsten, tantalum, or alloys thereof.

The deposition of the conductive material and the chemical polishing of the substrate may be performed in situ. The term “in situ” is broadly defined herein to performing sequential process in a given chamber or in a system, such as an integrated cluster tool arrangement, without exposing the material to intervening contamination environments. An in situ process typically minimizes process time and possible contaminants compared to relocating the substrate to other processing chambers or areas. For example, referring to FIGS. 1 and 2, the conductive material may be deposited in processing cell 240 of the processing station 218 and then polishing in cell 310 of processing station 215.

Feature formed on the substrate surface may include a dense array of narrow features and wide features formed in the substrate surface. Narrow features are generally considered to be about 1 μm or less in width and wide features are about 1 μm or greater in width, but the relative definitions may change with advances in semiconductor manufacturing that may redefine narrow and wide features. A dense array of features includes a plurality of narrow features. The conductive material typically forms protuberances, or peaks, over the narrow features. The conductive material forms recesses, or valleys, over the wide features compared to the conductive material deposited over the narrow features.

In operation, the substrate is disposed on a substrate support and exposed to a composition containing an oxidizing agent or an etchant. The oxidizing agent forms an oxide layer on the conductive material. Suitable oxidizing agents for the conductive materials described herein include hydrogen peroxide, nitric acid, and combinations thereof. The oxidizing agents may be present in amounts between about 5 volume % (vol %) and about 40 vol % of the solution. For example a composition may include between about 5 vol % and about 40 vol % of 35% hydrogen peroxide. A concentration between about 20 vol % and about 40 vol % of 35% hydrogen peroxide has been observed to provide improved uniformity and reduced dishing in chemically polishing substrates.

The etchant dissolves the oxide layer formed on the conductive material to remove the material from the substrate surface. Suitable etchants include sulfuric acid (H₂SO₄), phosphoric acid (H₃PO₄), or combinations thereof, of which phosphoric acid (H₃PO₄) is preferred. Suitable agents may also include carboxylic acids, such as acetic acids. Etchants may be present in the composition between about 0.5 vol % and about 20 vol % of the composition. For example, the etchant may comprise between about 1 vol % and about 5 vol % of 85% H₃PO₄. A 2 vol % concentration of 85% H₃PO₄has been observed to provide improved uniformity and reduced dishing in chemically polishing substrates. Increased dissolution of conductive material from the substrate surface has been observed with increasing acid concentrations.

The pH of the composition is generally about 7 or less, such as between about 0.5 and about 4. Polishing compositions having a pH between about 1 and about 2 have been observed to be effective in chemical polishing the substrate surfaces described herein.

Additionally, the invention contemplates the presence of additives for improving planarity. Organic additives, such as corrosion inhibitors, surfactants, chelating agents, and combinations thereof, may be used to increase or inhibit the dissolution rate of the oxide materials, thereby increasing the removal rate of the metal. Additives may comprise up to about 20 vol % (or up to about 20 weight % (wt. %)) of the total polishing composition, for example, between about 2 vol % and about 20 vol % of the polishing composition. A concentration of between about 5 vol % and about 10 vol % of the organic additives have been observed to provide effective planarization of the substrate surfaces described herein.

Organic additives include corrosion inhibitors. Corrosion inhibitors may be used to form passivation layers on the expose substrate surface to reduce or inhibit the dissolution process. Suitable corrosion inhibitors include compounds containing azole groups including alkyl-substituted azole derivatives, aryl-substituted azole derivatives, alkylaryl-substituted azole derivatives, (including halogen substituted derivatives thereof), and combinations thereof. Examples of corrosion inhibitors include benzotriazole (BTA), tolyltriazole (TTA), 5-methylbenzimidazole, 2-bromobenzyl benzimidazole, 2-chlorobenzyl benzymidazole, 2-bromophenyl benzimidazole, 2-chlorophenyl benzimidazole, 2-bromoethylphenyl benzimidazole, 2-chloroethylphenyl benzimidazole, 2-undecyl-4-methylimidazole, mercaptobenzotriazole, 5-methyl-1-benzotriazole (MBTA), and combinations thereof.

Corrosion inhibitors may comprise between about 50 parts per million (PPM), about 0.05 wt. %, and about 10,000 PPM, about 1 wt. % of the polishing composition, for example, between about 100 PPM and about 2000 PPM of the polishing composition. For example, BTA may comprise between about 0.01 wt. % and about 0.5 wt. % of the composition.

Alternatively, commercial organic additives that perform as inhibitors may also be used. An example of such an inhibitor is PC 5710, commercially available from Enthone, Inc., located in New Haven, Conn., for polishing compositions, which has been observed to control dissolution rates and improve substrate planarity. Such commercial organic additives may comprise up to about 20 vol % (or up to about 20 weight % (wt. %)) of the total polishing composition, for example, between about 2 vol % and about 20 vol % of the polishing composition. A concentration of between about 5 vol % and about 10 vol % of the organic additives have been observed to provide effective planarization of the substrate surfaces described herein.

Other organic additives may include chelating agents and surfactants. Chelating agents may be used to form complexing agents with material removed from the substrate surface to increase the solubility of the polishing composition and thus increase removal rate may be used in the polishing composition. Chelating agents may comprise up to about 20 vol % of the polishing composition. Examples of chelating agents include basic chelating agents, such as ammonia and amine containing compounds including ethylenediamine, and acid chelating agents, such as carboxylic acids, including citric and oxalic acids among others. Surfactants may also be used in the composition to form passivating layers on the substrate surface to improve selective removal of material from the protuberances formed on the substrate surface compared to removal from the recesses formed in the substrate surface by preferential absorption of the surfactants on the protuberances or the recesses.

The composition is maintained at a temperature between about 15° C. and about 65° C. during polishing. The composition is preferably maintained at about room temperature, or a temperature between about 20° C. and about 25° C. Increased oxidation of the substrate surface and increased dissolution of conductive material from the substrate surface has been observed with increasing process temperatures.

The composition is typically supplied to the substrate surface at a rate of up to about 600 ml/min for between about 5 seconds and about 300 seconds, such as between about 15 seconds and about 120 seconds to disposed polishing composition on the substrate surface. The deposited polishing composition may pool or form a “puddle” on the substrate surface for polishing, etching, the substrate surface. A total amount of polishing composition, such as between about 50 ml and about 500 ml, such as between about 100 ml and about 200 ml, for example 150 ml, may be used for polishing the substrate.

The substrate surface is exposed to the polishing composition for a period of time between about 5 seconds and about 300 seconds, such as between about 15 seconds and about 120 seconds. Additionally, the substrate may then be rotated between about 0 rpms and about 1000 rpms during the polishing process, for example, between about 0 rpms and about 10 rpms.

Agitation energy, also referred to as excitation energy, may be provided during chemical polishing. Agitation energy is believed to improve removal rate and dissolution of material by increasing the diffusion rate of materials removed from the substrate surface, such as metal ions. Agitation may be provided by ultrasonic or megasonic energy applied to the substrate support pedestal or substrate surface. Agitation is generally applied uniformly over the substrate surface. Any conventional generation of ultrasonic or megasonic agitation may be employed. A suitable pedestal capable of producing sufficient agitation for the process is the pedestal disposed in the Tempest™ processing chamber, commercially available from Applied Materials, of Santa Clara Calif.

An example of an agitation process includes applying ultrasonic energy between about 10 Watts (W) and about 250 W, for example, between about 10 W and about 100 W. The ultrasonic energy may have a frequency of about 25 kHz to about 200 kHz, typically greater than about 40 kHz since this is out of the audible range and contains fewer disruptive harmonics. Another example of an agitation process includes applying megasonic energy at a power density between about 0.05 watts/cm² (W/cm²) and about 1.5 W/cm², or between about 10 W and about 500 W for a 200 mm substrate, for example, about 0.5 W/cm² or about 150 W. The megasonic energy may have a frequency between about 0.2 MHz and about 2.0 MHz, for example 1 MHz. The applied power density or power may be modified based on the thickness of the layer being treated during the process. For example, satisfactory dissolution of copper ions for a layer of about 1000 Å thick has been observed by the application of a power density of about 0.5 W/cm² at 1 MHz.

If one or more sources of ultrasonic or megasonic energy are used, then simultaneous multiple frequencies may be used. The ultrasonic or megasonic energy may be applied between about 3 and about 600 seconds, but typically is used during the polishing process, but with longer or shorter time periods being used depending upon the material being polishing, the components of composition, or the degree of polishing.

Following processing the substrate may be transferred to another station, such as an annealing station 210, or transferred to another apparatus for subsequent processing, such as annealing or chemical mechanical processing to further planarize the surface or remove additional materials, such as barrier layer materials formed on the substrate surface.

Chemical polishing the substrate with the composition described herein has been observed to remove conductive material disposed in the protuberances on the substrate surface at a higher rate the material disposed in the recesses disposed in the substrate surface. The conductive material disposed in the protuberances is removed at between about 100 angstroms per minute (Å/min) and about 10,000 Å/min, for example, at about 1000 Å/min, greater than the conductive material disposed in the recesses. Reduction of the height differential between protuberances formed on the substrate surface and recess formed in the substrate surface has been observed to be reduced to as much as 60% by the process described herein. It has further been observed that the chemical polishing technique described herein effectively removes the bulk of the deposit of conductive material without the application of mechanical force while providing a reduction of the topographical disparity between the protuberances and the recesses of up to 60%.

Chemical Polishing Process Example

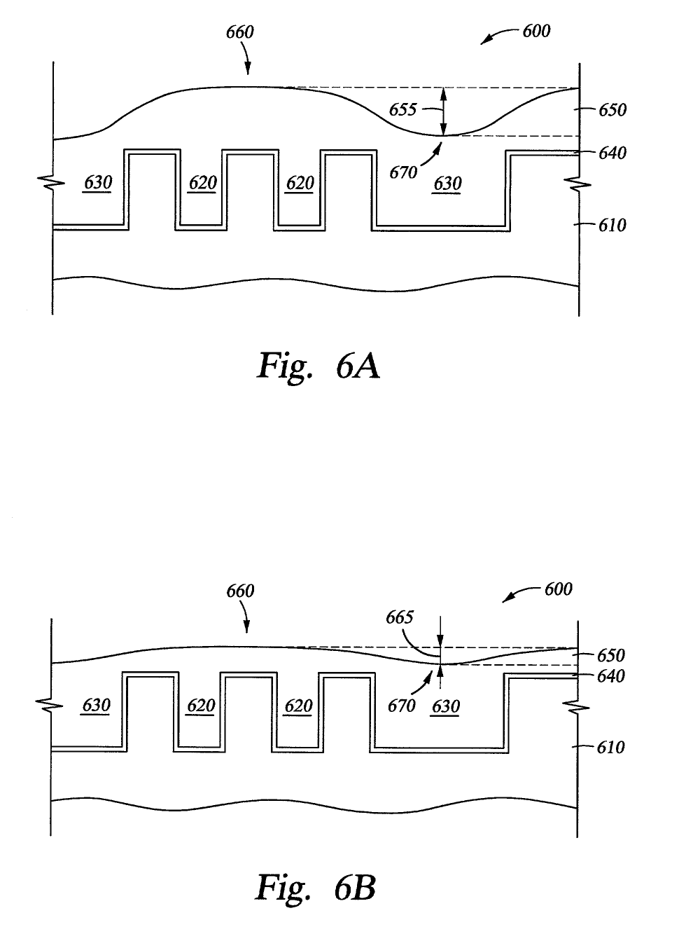

FIGS. 6A-6B are a series of schematic side views of a substrate 600 processed by one embodiment of the processes described herein. The substrate may include apertures formed in a dielectric material 610. The apertures may be of variable size and include narrow apertures 620 and wide apertures 630. For example, a narrow aperture 620 may include a feature having a width of about 0.1 μm with an aspect ratio (a ratio of height to width) of about 6:1 and a wide aperture 630 of about 5 μm or greater, of which widths between 0.2 μm and 5 μm are the most common. The dielectric material 610 is a low k material, such as silicon oxycarbide as described above. A barrier layer 640 of tantalum/tantalum nitride is deposited at about 1000 Å thick in the apertures and then a copper containing layer 650 (including a copper seed layer) is deposited between about 8000 Å and about 18,000 Å thick in the apertures and on the substrate surface. The variation or step-height difference 655 between the thickness of the protuberances 660 over narrow apertures 620 and of the recesses 670 over wide apertures 630 was observed to be an average of about 5000 Å.

The substrate is then transferred to the chemical polishing chamber and disposed on a substrate support. A composition comprising 40 vol % of 35% hydrogen peroxide, 2 vol % of phosphoric acid, 5 vol % of PC 5710, and deionized water is supplied to the processing chamber at a rate of about 600 ml/min for about 15 seconds and is maintained at a temperature of about 20° C. (room temperature) for 15 seconds for a total of 150 ml to polish the substrate surface. The substrate is rotated at a rotational rate of about 10 rpms. The substrate was exposed to the polishing composition for a total time of between about 60 and about 120 seconds. Agitation energy is supplied to the substrate support. The polished surface was examined and a step-height difference 665 between the protuberances 660 and the recesses 670 was reduced from the step-height difference 655 of about 5000 Å to as much as about 1500 Å, with an average step-height difference 665 of about 2800 Å. A corresponding removal rate between the protuberances and the recesses was observed to be between about 1100 Å/min and 2200 Å/min.

While not been bound to any particular theory, it is believed that the chemical polishing process described herein addresses the difficulty and planarizing the conductive material on the substrate surface by controlling the dissolution of copper ions into the solution. It is believed the dissolution of copper ions into the solution depends on the oxidation of copper to copper ions at the surface of the substrate in diffusion of copper ions into the bulk solution. The oxidizing agent and etchant reacts with the deposited material to establish a viscous layer of copper ions on the metal surface due to relatively low diffusion of copper ions into the bulk solution, thereby, forming a boundary layer. The dissolution of copper ions is controlled by the diffusion of the copper ions through the boundary layer. Copper can dissolve faster in the protuberances on the substrate surface because the ions from the protuberances diffuse through a smaller thickness of the boundary layer established adjacent substrate surface to the bulk electrolyte. This differential in rates of dissolution between the material disposed in the protuberances and the material disposed in the recesses leads to a planarization of the substrate surface.

While the foregoing is directed to embodiments of the present invention, other and further embodiments of the invention may be devised without departing from the basic scope thereof, and the scope thereof is determined by the claims that follow.

What is claimed is:

1. A method for processing a substrate in a processing system, comprising:
depositing conductive metal by an electroplating technique on a substrate surface;
exposing the substrate surface to a composition comprising an oxidizing agent and an etchant; and
removing conductive material from protuberances at a greater rate than conductive material from recesses.

2. The method of claim 1, wherein the composition comprises between about 5 vol % and about 40 vol % of the oxidizing agent, wherein the oxidizing agent is selected from the group of hydrogen peroxide, nitric acid, and combinations thereof.

3. The method of claim 1, wherein the composition comprises between about 0.5 vol % and about 20 vol % of the etchant, wherein the etchant is an acid selected from the group of sulfuric acid, phosphoric acid, acetic acid, and combinations thereof.

4. The method of claim 1, wherein the composition comprises between about 5 vol % and about 40 vol % of hydrogen peroxide, nitric acid, or combinations thereof, and between about 0.5 vol % and about 20 vol % of sulfuric acid, phosphoric acid, acetic acid, or combinations thereof.

5. The method of claim 1, wherein the composition further comprises organic additives selected from the group of corrosion inhibitors, chelating agents, surfactants, and combinations thereof.

6. The method of claim 5, wherein the organic additives comprise up to about 20 vol % of the composition.

7. The method of claim 1, further comprising rotating the substrate at a rotational speed of about 1000 rpm or less.

8. The method of claim 1, further comprising agitating the substrate.

9. The method of claim 1, wherein the electroplating technique and the exposing the substrate surface to a composition are performed in the same processing system.

10. The method of claim 9, wherein the electroplating technique and the exposing the substrate surface to a composition are performed in the same processing system.

11. A method for removing an electroplated conductive material from protuberances at a greater rate than conductive material from recesses formed on a substrate surface having a low k material and apertures formed therein, comprising:
depositing conductive metal on a substrate surface and in the apertures, wherein the conductive material forms protuberances and recesses on the substrate surface;
exposing the substrate surface to a composition comprising between about 5 vol % and about 40 vol % of an oxidizing agent and between about 0.5 vol % and about 20 vol % of an acid;
rotating the substrate at a rotational speed at about 1000 rpm or less during chemical polishing; and
applying a source of agitation to the substrate.

12. The method of claim 10, wherein the oxidizing agent is selected from the group of hydrogen peroxide, nitric acid, and combinations thereof.

13. The method of claim 10, wherein the etchant is an acid selected from the group of sulfuric acid, phosphoric acid, acetic acid, and combinations thereof.

14. The method of claim 10, wherein the composition further comprises organic additives selected from the group of corrosion inhibitors, chelating agents, surfactants, and combinations thereof.

15. The method of claim 14, wherein the organic additives comprise up to about 20 vol % of the composition.

16. The method of claim 10, wherein the conductive material is deposited by an electroplating technique.

17. The method of claim 16, wherein the electroplating technique and the exposing the substrate surface to a composition are performed in the same processing system.

18. A method for polishing a substrate, comprising:
electroplating a metal layer on a substrate surface;
removing at least a portion of the metal layer in situ by a method comprising:
exposing the substrate surface to a composition comprising between about 5 vol % and about 40 vol % of hydrogen peroxide, nitric acid, or combinations thereof, and between about 0.5 vol % and about 20 vol % of sulfuric acid, phosphoric acid, acetic acid, or combinations thereof;
rotating the substrate at a rotational speed at about 10 rpm or less; and
applying a source of agitation to the substrate.

19. The method of claim 18, wherein the composition further comprises organic additives selected from the group of corrosion inhibitors, chelating agents, surfactants, and combinations thereof.

20. The method of claim 19, wherein the organic additives comprise up to about 20 vol % of the composition.

21. A method for planarizing a patterned substrate having an electroplated conductive metal layer disposed thereon, the method comprising:
exposing the substrate to a liquid composition comprising a first component selected from the group of hydrogen peroxide, nitric acid, and combinations thereof, and a second component selected from the group of sulfuric acid, phosphoric acid, acetic acid, and combinations thereof; and
rotating the substrate at a rotational speed of the order of 1000 rpm or less.

22. The method of claim 21, wherein the liquid composition further comprises an organic additive selected from the group of corrosion inhibitors, chelating agents, surfactants, and combinations thereof.

23. The method of claim 21, further comprising agitating the substrate.

24. The method of claim 24, wherein the composition comprises between about 0.5 vol % and about 40 vol % of the first component, and about 0.5 vol % and about 20 vol % of the second component.

25. A processing system for processing a substrate comprising:
an electroplating processing mainframe having a transfer robot and one or more chemical polishing cells;
a chemical polishing composition applicator coupled to the mainframe, the applicator comprising a nozzle positioned to distribute a chemical polishing composition over the substrate; and
a chemical polishing composition supply fluidly connected to the chemical polishing composition applicator.

26. The system of claim 25, wherein the nozzle is disposed in a chemical polishing (CP) cell.

27. The system of claim 26, wherein the CP cell comprises a pedestal for supporting the substrate.

28. The system of claim 27, wherein the CP cell further comprises an actuator disposed in connection with the pedestal to rotate the pedestal.

29. The system of claim 27, wherein the CP cell further comprises a rinse fluid inlet disposed proximate to the pedestal and fluidly connected to a supply of rinsing fluid.

30. The system of claim 27, wherein the nozzle is disposed proximate to a center of the pedestal and coupled to an articulating member.

31. The system of claim 30, further comprising an actuator coupled to the articulating member to move the nozzle from a central position above the pedestal to a peripheral position proximate to a sidewall of the CP cell.

32. The system of claim 27, wherein the CP cell further comprises a source of agitation energy coupled to the pedestal.
